(19) United States
(12) Patent Application Publication
(10) Pub. No.: US 2025/0309733 A1
(43) Pub. Date: Oct. 2, 2025

(54) ELECTRIC APPARATUS

(71) Applicant: HONDA MOTOR CO., LTD., Tokyo (JP)

(72) Inventors: Yoshihisa Kubota, Wako-shi (JP); Kiyoshi Asami, Wako-shi (JP)

(21) Appl. No.: 19/037,315

(22) Filed: Jan. 27, 2025

(30) Foreign Application Priority Data
Mar. 26, 2024 (JP) 2024-049788

(51) Int. Cl. H02K 11/33; H02K 1/16; H02K 3/28

(52) U.S. Cl. CPC H02K 11/33; H02K 1/16; H02K 3/28

(57) ABSTRACT

An electric apparatus includes a rotary electric machine, an electric power control unit, and an AC electric power source connection portion. The rotary electric machine includes a stator core on which a slot shared by a β-phase first coil and a β-phase second coil is formed. The electric power control unit includes: a third full-bridge circuit and a fourth full-bridge circuit that are connected to each of both ends of each β-phase coil; and a third connection-disconnection device and a fourth connection-disconnection device that are connected between each of one end of each β-phase coil and each full-bridge circuit. The AC electric power source connection member is connected to both ends of each connection-disconnection device such that magnetic fluxes are cancelled each other when a current supplied from an external AC electric power source to the β-phase coils that are magnetically coupled flows.

### CROSS-REFERENCE TO RELATED APPLICATION

Priority is claimed on Japanese Patent Application No. 2024-049788, filed on Mar. 26, 2024, the contents of which are incorporated herein by reference.

### BACKGROUND

### Field of the Invention

The present invention relates to an electric apparatus.

### Background

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In the related art, for example, an electric vehicle is known which converts AC electric power supplied from an external electric power source to DC electric power by a combination of a stator winding of a plurality of phases of a motor and a bridge circuit of a plurality of phases by a switching element (for example, refer to Japanese Unexamined Patent Application, First Publication No. 2012-70613). In this electric vehicle, by a current from the external electric power source being supplied to a connection point that divides the stator winding of each phase into two portions, magnetic fluxes in a magnetic circuit of the motor cancel each other out, and generation of a torque is prevented.

### SUMMARY

In the technique relating to charging and electric power supply in a mobility on which a secondary battery is mounted, it is a problem to improve the charging speed and efficiency of AC charging by an external electric power source. For example, as in the electric vehicle of the related art described above, when a mutual magnetic flux coupling is decreased by providing a plurality of coils on the divided stator winding of each phase, and an inductance effective for controllability is increased, there is a possibility that it becomes difficult to increase the voltage increase ratio. If it is difficult to increase the voltage increase ratio at the time of conversion from the AC electric power to the DC electric power, another voltage increase operation is required in order to ensure the desired DC voltage, and there is a possibility that it is impossible to improve the charging speed and the efficiency.

The present application aims at achieving an improvement in the charging speed and efficiency of AC charging. Further, the present application contributes to energy efficiency.

An electric apparatus (for example, an electric apparatus 10 in the embodiment) according to a first aspect of the present invention includes: an electricity storage device (for example, an electricity storage device 11 in the embodiment) and a rotary electric machine (for example, a rotary electric machine 16 (M) in the embodiment); an electric power control unit (for example, an electric power control unit 10a in the embodiment) that is connected to the electricity storage device and the rotary electric machine and controls electric power transfer of each of the electricity storage device and the rotary electric machine; and an electric power source connection member (for example, an AC electric power source connection portion 15 in the embodiment) that connects the electric power control unit to an external electric power source, wherein the rotary electric machine includes: a first coil (for example, a β-phase first coil 33 (β1) in the embodiment); a second coil (for example, a β-phase second coil 34 (β2) in the embodiment); and a stator core (for example, a stator core 42 in the embodiment) on which a slot (for example, a slot 43 in the embodiment) shared by the first coil and the second coil is formed, the electric power control unit includes: a first full-bridge circuit (for example, a third full-bridge circuit 13a in the embodiment) that is connected to both ends of the first coil; a second full-bridge circuit (for example, a fourth full-bridge circuit 13b in the embodiment) that is connected to both ends of the second coil; a first connection-disconnection device (for example, a third connection-disconnection device 35 in the embodiment) that is connected between one end of the first coil and the first full-bridge circuit; and a second connection-disconnection device (for example, a fourth connection-disconnection device 36 in the embodiment) that is connected between one end of the second coil and the second full-bridge circuit, and the electric power source connection member is connected to both ends of each of the first connection-disconnection device and the second connection-disconnection device such that magnetic fluxes are cancelled each other when a current supplied from the external electric power source to the first coil and the second coil that are magnetically coupled flows.

A second aspect is the electric apparatus according to the first aspect described above, wherein the rotary electric machine may include a third coil (for example, an α-phase first coil 23 (α1) in the embodiment) and a fourth coil (for example, an α-phase second coil 24 (α2) in the embodiment) that share the slot of the stator core, and the electric power control unit may include: a third full-bridge circuit (for example, a first full-bridge circuit 12a in the embodiment) that is connected to both ends of the third coil; a fourth full-bridge circuit (for example, a second full-bridge circuit 12b in the embodiment) that is connected to both ends of the fourth coil; a third connection-disconnection device (for example, a first connection-disconnection device 25 in the embodiment) that is connected between positive electrodes of the third full-bridge circuit and the fourth full-bridge circuit; and a fourth connection-disconnection device (for example, a second connection-disconnection device 26 in the embodiment) that is connected between negative electrodes of the third full-bridge circuit and the fourth full-bridge circuit.

A third aspect is the electric apparatus according to the first aspect described above, wherein when the electricity storage device is charged by the external electric power source, each of the first connection-disconnection device and the second connection-disconnection device may be set to be in a disconnection state, and the first full-bridge circuit and the second full-bridge circuit may set a flow direction in the first coil and the second coil of the current supplied from the external electric power source such that the magnetic fluxes of the first coil and the second coil that are magnetically coupled cancel each other out.

A fourth aspect is the electric apparatus according to the first aspect described above, wherein the electric power control unit may stop a switching operation of the first full-bridge circuit or the second full-bridge circuit when the voltage of the external electric power source is equal to or more than a predetermined voltage.

A fifth aspect is the electric apparatus according to the first aspect described above which may include: an electric power source connection-disconnection device (for example, a fifth connection-disconnection device 39 in the embodiment) that is connected between the electric power source connection member and the first connection-disconnection device or the second connection-disconnection device, wherein the electric power source connection-disconnection device may be set to be in a connection state when the voltage of the external electric power source is less than a predetermined voltage, and the electric power source connection-disconnection device may be set to be in a disconnection state when the voltage of the external electric power source is equal to or more than the predetermined voltage.

According to the first aspect described above, by supplying electric power to the first coil and the second coil that are arranged in the same slot such that the magnetic fluxes cancel each other out, it is possible to prevent the rotary electric machine from generating torque, and it is possible to increase the voltage increase ratio by a relatively small leakage inductance.

The first coil and the second coil are, for example, an open-end winding that is connected to each full-bridge circuit, and thereby, for example, as compared with a three-phase coil or the like, it is possible to increase the voltage applied to each coil with respect to a charging voltage and increase the charging speed.

In the case of the second aspect described above, the combination of the third coil and the fourth coil of the rotary electric machine, the third full-bridge circuit, and the fourth full-bridge circuit can function as an insulation-type bidirectional DC-DC converter. For example, in the case of the voltage increase operation, it is possible to perform rapid charging with respect to the voltage of the electricity storage device that is larger than the charging voltage by the external electric power source.

In the case of the third aspect described above, it is possible to prevent the rotary electric machine from generating torque, and it is possible to increase the voltage increase ratio by a relatively small leakage inductance. It is possible to increase the voltage applied to each coil with respect to a charging voltage, and it is possible to increase the charging speed.

In the case of the fourth aspect described above, when the voltage of the external electric power source is equal to or more than the predetermined voltage, by supplying electric power only to the first coil or the second coil, it is possible to improve the charging efficiency while reducing distortion of a current or the like by a relatively large inductance.

In the case of the fifth aspect described above, when the voltage of the external electric power source is less than the predetermined voltage, by supplying electric power such that the magnetic fluxes of the first coil and the second coil cancel each other out, it is possible to increase the voltage increase ratio by a relatively small leakage inductance. When the voltage of the external electric power source is equal to or more than the predetermined voltage, it is possible to improve the charging efficiency while reducing distortion of a current or the like by a relatively large inductance.

### BRIEF DESCRIPTION OF THE DRAWINGS

FIG. 1 is a view showing the configuration of an electric apparatus of an embodiment of the present invention.

FIG. 2 is a configuration view of each full-bridge circuit and a rotary electric machine in the electric apparatus of the embodiment of the present invention.

FIG. 3 is a block diagram showing a functional configuration of an electronic control unit at the time of AC charging in the electric apparatus of the embodiment of the present invention.

FIG. 4 is a circuit diagram showing the flow of a current in each state of a first mode, a second mode, a third mode, and a fourth mode in the state of a mirror drive at the time of AC charging in the electric apparatus of the embodiment of the present invention.

FIG. 5 is a circuit diagram showing an example of the flow of a current in each state of the mirror drive and a single drive at the time of AC charging in the electric apparatus of the embodiment of the present invention.

FIG. 6 is a view showing an example of a correspondence relationship between an increased voltage and a duty of switching in each state of the mirror drive and the single drive at the time of AC charging in the electric apparatus of the embodiment of the present invention.

FIG. 7 is a configuration view of a rotary electric machine of an electric apparatus in a modification example of the embodiment of the present invention.

### DESCRIPTION OF EMBODIMENTS

Hereinafter, an electric apparatus according to an embodiment of the present invention will be described referring to the accompanying drawings.

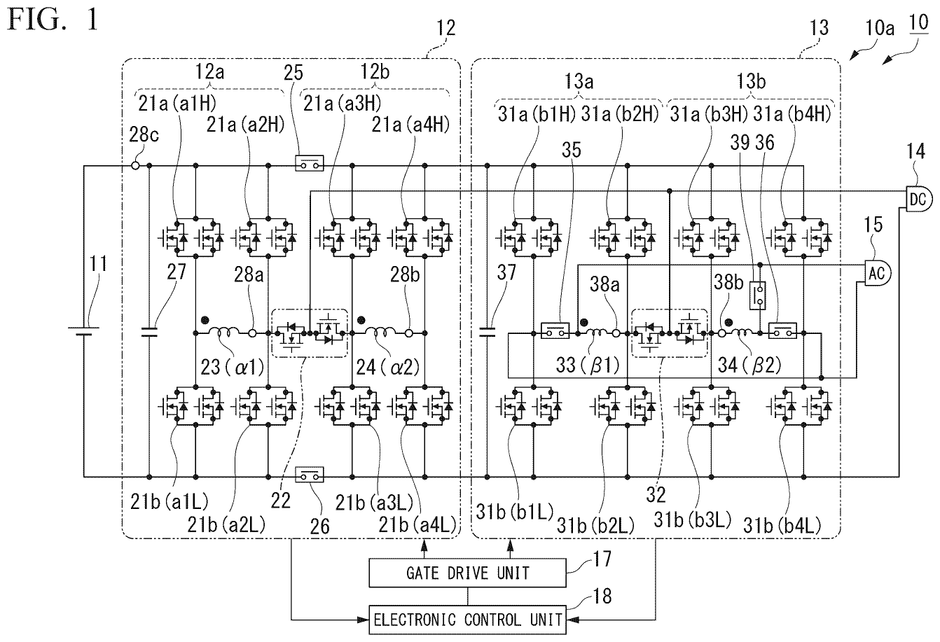

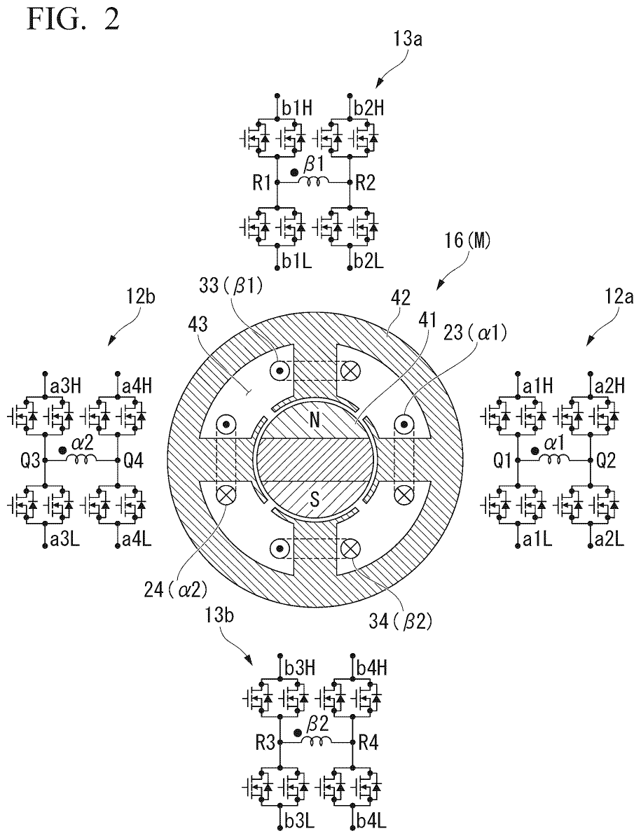

FIG. 1 is a view showing the configuration of an electric apparatus 10 of an embodiment. FIG. 2 is a configuration view of full-bridge circuits 12a, 12b, 13a, 13b and a rotary electric machine 16 in the electric apparatus 10 of the embodiment.

The electric apparatus 10 of the embodiment is mounted, for example, on an electric vehicle, an electric movable body, an electric machine, an electric power source apparatus, and the like. The electric vehicle is, for example, an electric automobile that includes a rotary electric machine as a power source, a saddle riding vehicle, a kick skater, a hybrid vehicle made by combining a rotary electric machine and an internal combustion engine, a fuel cell vehicle made by combining an electricity storage device and a fuel cell, and the like. The electric movable body is, for example, a robot, a flying vehicle, a movable body on water, an underwater movable body, and the like. The electric machine is, for example, a construction machinery that includes a rotary electric machine as a power source and the like. The electric power source apparatus is, for example, a stationary or mobile electric power source apparatus that performs discharging and charging of an electricity storage device and the like.

### (Electric Apparatus)

As shown in FIG. 1 and FIG. 2, the electric apparatus 10 of the embodiment includes, for example, an electricity storage device 11, a first electric power conversion portion 12, a second electric power conversion portion 13, a DC electric power source connection portion 14, an AC electric power source connection portion 15 (electric power source connection member), a rotary electric machine 16 (M), a gate drive unit 17, and an electronic control unit 18. For example, the first electric power conversion portion 12, the second electric power conversion portion 13, the DC electric power source connection portion 14, the AC electric power source connection portion 15, the gate drive unit 17, and the electronic control unit 18 constitute an electric power control unit 10a. The electricity storage device 11 is connected to the first electric power conversion portion 12 and the second electric power conversion portion 13 described later.

The electricity storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, or a compound battery made by combining a secondary battery and a capacitor. Each battery cell repeatedly performs charging and discharging. The electricity storage device 11 transfers electric power to and from the rotary electric machine 16 via the electric power control unit 10a. The electricity storage device 11 is charged by an external electric power source (an external DC electric power source and an external AC electric power source).

The first electric power conversion portion 12 includes a first full-bridge circuit 12a and a second full-bridge circuit 12b.

Each of the first full-bridge circuit 12a and the second full-bridge circuit 12b includes, for example, a so-called H-bridge circuit formed of a plurality of switching elements connected in two phases by bridge connection. Each switching element is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element is, for example, an N-channel type MOSFET.

The plurality of switching elements are, for example, a pair of transistors forming each of high-side arm and low-side arm element portions 21a, 21b that form a pair in each phase. Each pair of transistors of each element portion 21a, 21b are, for example, a pair of transistors that are connected in parallel.

Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 connected between neutral points Q2, Q3 of the first full-bridge circuit 12a and the second full-bridge circuit 12b. The neutral point Q2 of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the neutral point Q2 is a connection point between a source of the high-side arm element portion 21a (a2H) and a drain of the low-side arm element portion 21b (a2L). The neutral point Q3 of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the neutral point Q3 is a connection point between a source of the high-side arm element portion 21a (a3H) and a drain of the low-side arm element portion 21b (a3L).

The first switch 22 is, for example, a bidirectional switch formed of two switching elements. Each switching element is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. Each transistor may include, for example, a rectifier element such as a reflux diode which is connected in parallel between a collector and an emitter in a forward direction toward the collector from the emitter. The first switch 22 switches conduction and cutoff of a current between the neutral points Q2, Q3 by ON (conduction)/OFF (cutoff) of the two transistors.

The first electric power conversion portion 12 is connected to an α-phase first coil 23 (α1) and an α-phase second coil 24 (α2) of the rotary electric machine 16 described later. The α-phase first coil 23 is connected between neutral points Q1, Q2 of the first full-bridge circuit 12a. The α-phase second coil 24 (α2) is connected between neutral points Q3, Q4 of the second full-bridge circuit 12b. The neutral point Q1 of the first full-bridge circuit 12a is, for example, a connection point between a high-side arm element portion 21a (a1H) and a low-side arm element portion 21b (a1L) that are connected in series in the first phase of the first full-bridge circuit 12a. For example, the neutral point Q1 is a connection point between a source of the high-side arm element portion 21a (a1H) and a drain of the low-side arm element portion 21b (a1L). The neutral point Q4 of the second full-bridge circuit 12b is, for example, a connection point between a high-side arm element portion 21a (a4H) and a low-side arm element portion 21b (a4L) that are connected in series in the second phase of the second full-bridge circuit 12b. For example, the neutral point Q4 is a connection point between a source of the high-side arm element portion 21a (a4H) and a drain of the low-side arm element portion 21b (a4L).

The first electric power conversion portion 12 includes a first connection-disconnection device 25 that is connected between positive electrodes of the first full-bridge circuit 12a and the second full-bridge circuit 12b and a second connection-disconnection device 26 that is connected between negative electrodes of the first full-bridge circuit 12a and the second full-bridge circuit 12b.

Each of the first connection-disconnection device 25 and the second connection-disconnection device 26 is, for example, a contactor and switches between ON (conduction) and OFF (cutoff) of the connection between the first full-bridge circuit 12a and the second full-bridge circuit 12b.

The first electric power conversion portion 12 includes, for example, a capacitor (condenser) 27 that is connected between the positive electrode and the negative electrode. For example, the capacitor 27 smooths voltage variation generated in accordance with a switching operation between ON (conduction) and OFF (cutoff) of each switching element of the first electric power conversion portion 12.

The first electric power conversion portion 12 includes, for example, a first current sensor 28a arranged between the α-phase first coil 23 (α1) and the neutral point Q2, a second current sensor 28b arranged between the α-phase second coil 24 (α2) and the neutral point Q4, and a third current sensor 28c arranged between the electricity storage device 11 and the first electric power conversion portion 12.

For example, the first current sensor 28a detects a current that flows through the α-phase first coil 23 (α1). The second current sensor 28b detects a current that flows through the α-phase second coil 24 (α2).

The third current sensor 28c detects a current that flows between the first electric power conversion portion 12 and the electricity storage device 11.

The second electric power conversion portion 13 includes a third full-bridge circuit 13a and a fourth full-bridge circuit 13b.

Each of the third full-bridge circuit 13a and the fourth full-bridge circuit 13b includes, for example, a so-called H-bridge circuit formed of a plurality of switching elements connected in two phases by bridge connection. Each switching element is, for example, a transistor of a SiC or the like, such as a MOSFET or an IGBT. Each switching element is, for example, an N-channel type MOSFET.

The plurality of switching elements are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 that is connected between neutral points R2, R3 of the third full-bridge circuit 13a and the fourth full-bridge circuit 13b. The neutral point R2 of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the neutral point R2 is a connection point between a source of the high-side arm element portion 31a (b2H) and a drain of the low-side arm element portion 31b (b2L). The neutral point R3 of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the neutral point R3 is a connection point between a source of the high-side arm element portion 31a (b3H) and a drain of the low-side arm element portion 31b (b3L).

The second switch 32 is, for example, a bidirectional switch formed of two switching elements. Each switching element is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the neutral points R2, R3 by ON (conduction)/OFF (cutoff) of the two transistors.

Each transistor may include a rectifier element such as a reflux diode which is connected in parallel between a collector and an emitter in a forward direction toward the collector from the emitter.

The second electric power conversion portion 13 is connected to a β-phase first coil 33 (β1) and a β-phase second coil 34 (β2) of the rotary electric machine 16 described later. The β-phase first coil 33 is connected between neutral points R1, R2 of the third full-bridge circuit 13a. The β-phase second coil 34 (β2) is connected between neutral points R3, R4 of the fourth full-bridge circuit 13b. The neutral point R1 of the third full-bridge circuit 13a is, for example, a connection point between a high-side arm element portion 31a (b1H) and a low-side arm element portion 31b (b1L) that are connected in series in the first phase of the third full-bridge circuit 13a. For example, the neutral point R1 is a connection point between a source of the high-side arm element portion 31a (b1H) and a drain of the low-side arm element portion 31b (b1L). The neutral point R4 of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the neutral point R4 is a connection point between a source of the high-side arm element portion 31a (b4H) and a drain of the low-side arm element portion 31b (b4L).

The second electric power conversion portion 13 includes a third connection-disconnection device 35 that is connected between one end of the β-phase first coil 33 (β1) and the third full-bridge circuit 13a and a fourth connection-disconnection device 36 that is connected between one end of the β-phase second coil 34 (β2) and the fourth full-bridge circuit 13b.

Each of the third connection-disconnection device 35 and the fourth connection-disconnection device 36 is, for example, a contactor. The third connection-disconnection device 35 is connected, for example, between the one end of the β-phase first coil 33 (β1) and the neutral point R1 of the first phase of the third full-bridge circuit 13a and switches between ON (conduction) and OFF (cutoff) of the connection between the β-phase first coil 33 (β1) and the neutral point R1. The fourth connection-disconnection device 36 is connected, for example, between the one end of the β-phase second coil 34 (β2) and the neutral point R4 of the second phase of the fourth full-bridge circuit 13b and switches between ON (conduction) and OFF (cutoff) of the connection between the β-phase second coil 34 (β2) and the neutral point R4.

The second electric power conversion portion 13 includes, for example, a capacitor (condenser) 37 that is connected between the positive electrode and the negative electrode. For example, the capacitor 37 smooths voltage variation generated in accordance with a switching operation between ON (conduction) and OFF (cutoff) of each switching element of the second electric power conversion portion 13.

The second electric power conversion portion 13 includes, for example, a fourth current sensor 38a arranged between the β-phase first coil 33 (β1) and the neutral point R2 and a fifth current sensor 38b arranged between the β-phase second coil 34 (β2) and the neutral point R4.

For example, the fourth current sensor 38a detects a current that flows through the β-phase first coil 33 (β1). The fifth current sensor 38b detects a current that flows through the β-phase second coil 34 (β2).

The second electric power conversion portion 13 includes, for example, a fifth connection-disconnection device 39 (electric power source connection-disconnection device) that is connected between the AC electric power source connection portion 15 described later and a connection point between the β-phase second coil 34 (β2) and the fourth connection-disconnection device 36. The fifth connection-disconnection device 39 is, for example, a contactor. The fifth connection-disconnection device 39 switches between ON (conduction) and OFF (cutoff) of the connection between the AC electric power source connection portion 15 and the β-phase second coil 34 (β2).

The DC electric power source connection portion 14 and the AC electric power source connection portion 15 include, for example, a connection device (connector) or the like for DC electric power and for AC electric power of a predetermined standard. The DC electric power source connection portion 14 and the AC electric power source connection portion 15 are connected, for example, to a DC electric power source (external DC electric power source) and an AC electric power source (external AC electric power source) at the outside on the basis of a commercial electric power source or the like connected to an electric power system.

The DC electric power source connection portion 14 is connected, for example, to the negative electrode of the second electric power conversion portion 13 and to a neutral point (that is, a point between the two transistors connected reversely in series) of each of the first switch 22 and the second switch 32.

The AC electric power source connection portion 15 is connected, for example, to each of the first neutral point R1 and the fourth neutral point R4 of the second electric power conversion portion 13 and to the fifth connection-disconnection device 39 and the connection point between the β-phase first coil 33 (β1) and the third connection-disconnection device 35.

The rotary electric machine 16 (M) is, for example, a two-phase AC brushless DC motor. The rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42.

The rotor 41 includes a field permanent magnet. Each coil α1, α2, β1, β2 that generates a rotating magnetic field which rotates the rotor 41 is attached to the stator core 42.

The α-phase first coil 23 (α1), the α-phase second coil 24 (α2), the β-phase first coil 33 (β1), and the β-phase second coil 34 (β2) are so-called open-end coils, and ends of the coils α1, α2, β1, β2 are not connected to each other (that is, the coils α1, α2, β1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the different teeth of the stator core 42 in the same direction when seen from an axis direction along a center axis of the rotary electric machine 16 (M). The α-phase first coil 23 (α1) and the α-phase second coil 24 (α2) are arranged, for example, so as to share part of a slot 43 formed in the stator core 42 and are magnetically coupled to each other in the same polarity.

The β-phase first coil 33 (β1) and the β-phase second coil 34 (β2) cause, for example, a spatial phase difference from each other to be zero and are wound with respect to the different teeth of the stator core 42 in the same direction when seen from the axis direction along the center axis of the rotary electric machine 16 (M). The β-phase first coil 33 (β1) and the β-phase second coil 34 (β2) are arranged, for example, so as to share part of the slot 43 formed in the stator core 42 and are magnetically coupled to each other in the same polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°.

For example, each coil α1, α2, β1, β2 is attached to the stator core 42 by concentrated winding, distributed winding, or the like, and the coils α1, α2, β1, β2 have the same number of winding as one another.

The rotary electric machine 16 (M) generates rotation power by performing a power running operation using electric power supplied from the first electric power conversion portion 12 and the second electric power conversion portion 13. For example, when the rotary electric machine 16 (M) is connected to a wheel of the vehicle, the rotary electric machine 16 (M) generates a travel drive force by the electric power supplied from the first electric power conversion portion 12 and the second electric power conversion portion 13. The rotary electric machine 16 (M) may generate electric power by performing a regeneration operation using rotation power input from the wheel side of the vehicle. For example, when the rotary electric machine 16 (M) is connected to the internal combustion engine of the vehicle, the rotary electric machine 16 (M) may generate electric power using the power of the internal combustion engine.

The gate drive unit 17 switches between ON (conduction) and OFF (cutoff) of each connection-disconnection device 25, 26, 35, 36, 39 and each switching element of the first electric power conversion portion 12 and the second electric power conversion portion 13 on the basis of a control signal received from the electronic control unit 18. For example, the gate drive unit 17 switches between ON (conduction) and OFF (cutoff) of each switching element of each full-bridge circuit 12a, 12b, 13a, 13b by outputting a gate signal generated by amplification, level shift, and the like of the control signal.

The electronic control unit 18 integrally controls an operation of each of the electric power control unit 10a and the rotary electric machine 16 (M). For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least part of the electronic control unit 18 may be an integrated circuit such as a LSI (Large Scale Integration).

The electronic control unit 18 generates a control signal indicating a timing when each connection-disconnection device 25, 26, 35, 36, 39 and each switching element of the first electric power conversion portion 12 and the second electric power conversion portion 13 are driven to ON (conduction) and OFF (cutoff). The electronic control unit 18 inputs the generated control signal to the gate drive unit 17.

### (Control Operation of Electric Apparatus)

The electronic control unit 18 sets the first connection-disconnection device 25 and the second connection-disconnection device 26 to be in an ON (conduction) state in the case of the power running operation or the regeneration operation of the rotary electric machine 16 (M). The electronic control unit 18 switches between a state in which the α-phase coils α1, α2 are connected in series and the β-phase coils β1, β2 are connected in series, and a state in which the α-phase coils α1, α2 are connected in parallel and the β-phase coils β1, β2 are connected in parallel by switching between ON (conduction) and OFF (cutoff) of the first switch 22 and the second switch 32.

The electronic control unit 18 performs, for example, a feedback control or the like of a current in which a current detection value of the rotary electric machine 16 (M) and a current target value in response to the torque command value of the rotary electric machine 16 (M) are used and generates a control signal that commands the driving of each switching element of the first electric power conversion portion 12 and the second electric power conversion portion 13.

At the time of DC charging, that is, when the electricity storage device 11 is charged by the external DC electric power source connected to the DC electric power source connection portion 14, the electronic control unit 18 sets the first connection-disconnection device 25 and the second connection-disconnection device 26 to be in an ON (conduction) state. The electronic control unit 18 causes each of the combination of the α-phase coils α1, α2 and the first electric power conversion portion 12 and the combination of the β-phase coils β1, β2 and the second electric power conversion portion 13 to function as a non-insulation type DC-DC converter that performs a voltage increase operation by a so-called chopper control, for example, with respect to the external DC electric power source having a lower voltage than that of the electricity storage device 11.

At the time of AC charging, that is, when the electricity storage device 11 is charged by the external AC electric power source connected to the AC electric power source connection portion 15, the electronic control unit 18 sets the first connection-disconnection device 25 and the second connection-disconnection device 26 to be in an OFF (cutoff) state for insulation.

The electronic control unit 18 sets, for example, the α-phase first coil 23 (α1) and the α-phase second coil 24 (α2) that are magnetically coupled to each other in the same polarity to be a coil of a DC conversion phase (α phase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (a voltage increase and a voltage decrease) converter.

The electronic control unit 18 sets, for example, the β-phase first coil 33 (β1) and the β-phase second coil 34 (β2) that are magnetically coupled to each other in the same polarity to be a coil of an AC electric power source input phase (β phase) connected to the external AC electric power source. The electronic control unit 18 causes, for example, the combination of the β-phase coils β1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by bridge connection. The so-called totem pole PFC is a PFC that includes a pair of switching elements of the same conductivity type which are connected (totem pole connection) in series in the same direction. The electronic control unit 18 performs the power factor correction of an input voltage Vac and an input current Iac while performing rectification of AC electric power received from the external AC electric power source into DC electric power and increasing the voltage, for example, by controlling the switching of each switching element in each full-bridge circuit 13a, 13b of the second electric power conversion portion 13.

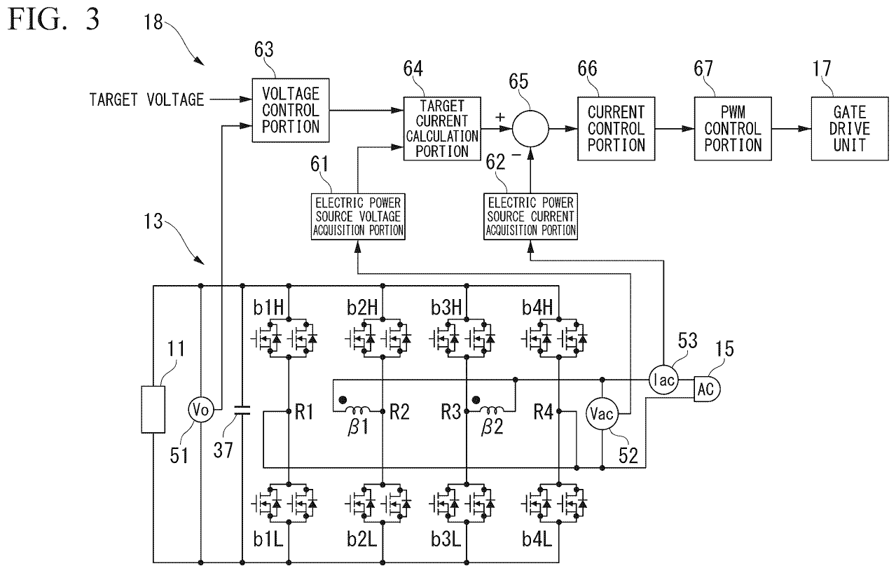

FIG. 3 is a block diagram showing a functional configuration of the electronic control unit 18 at the time of AC charging in the electric apparatus 10 of the embodiment.

As shown in FIG. 3, the second electric power conversion portion 13 includes, for example, an output voltage sensor 51 that detects an output voltage Vo of both ends (between the positive electrode and the negative electrode) of the capacitor 37, an input voltage sensor 52 that detects an input voltage Vac of the external AC electric power source, and an input current sensor 53 that detects an input current Iac of the external AC electric power source.

The electronic control unit 18 includes, for example, an electric power source voltage acquisition portion 61, an electric power source current acquisition portion 62, a voltage control portion 63, a target current calculation portion 64, a subtraction portion 65, a current control portion 66, and a PWM control portion 67.

The electric power source voltage acquisition portion 61 outputs, for example, a voltage amplitude |Vac| of an input voltage Vac that is input from the input voltage sensor 52.

The electric power source current acquisition portion 62 outputs, for example, a current amplitude |Iac| of an input current Iac that is input from the input current sensor 53.

The voltage control portion 63 outputs a current amplitude target value of the input current Iac of the external AC electric power source, for example, by a PI (proportional-integral) control or the like on the basis of a target voltage and the output voltage Vo that is input from the output voltage sensor 51.

The target current calculation portion 64 outputs a target current synchronized with the input voltage Vac of the external AC electric power source while performing correction in accordance with the voltage amplitude |Vac|, for example, on the basis of the voltage amplitude |Vac| that is output from the electric power source voltage acquisition portion 61 and a current amplitude target value that is output from the voltage control portion 63.

The subtraction portion 65 outputs, for example, a current deviation obtained by subtraction between the target current that is output from the target current calculation portion 64 and the current amplitude |Iac| that is output from the electric power source current acquisition portion 62.

The current control portion 66 outputs the duty ratio of a voltage command while performing a control such that phases of the input voltage Vac and the input current Iac of the external AC electric power source are matched to be in phase, for example, by the PI (proportional-integral) control or the like on the basis of the current deviation that is output from the subtraction portion 65. The duty ratio of the voltage command defines the ratio of an on-time of the switching elements (that is, high-side arm and low-side arm switching elements of each phase) that form a pair in each phase of each full-bridge circuit 13a, 13b of the second electric power conversion portion 13 to a switching cycle.

The PWM control portion 67 generates a control signal indicating a timing when each switching element of each full-bridge circuit 13a, 13b of the second electric power conversion portion 13 is driven between ON (conduction) and OFF (cutoff), for example, by a pulse width modulation operation based on the duty ratio of the voltage command that is output from the current control portion 66.

The electronic control unit 18 sets the fifth connection-disconnection device 39 to be in an ON (conduction) state, for example, when the magnitude of an effective value or the like of the voltage of the external AC electric power source is less than a predetermined voltage. The ON (conduction) state of the fifth connection-disconnection device 39 is a state of a mirror drive in which a current flows from the external AC electric power source to the β-phase first coil 33 (β1) and the β-phase second coil 34 (β2). The electronic control unit 18 sets the fifth connection-disconnection device 39 to be in an OFF (cutoff) state, for example, when the magnitude of an effective value or the like of the voltage of the external AC electric power source is equal to or more than the predetermined voltage. The OFF (cutoff) state of the fifth connection-disconnection device 39 is the state of a single drive in which a current flows from the external AC electric power source only to the β-phase first coil 33 (β1).

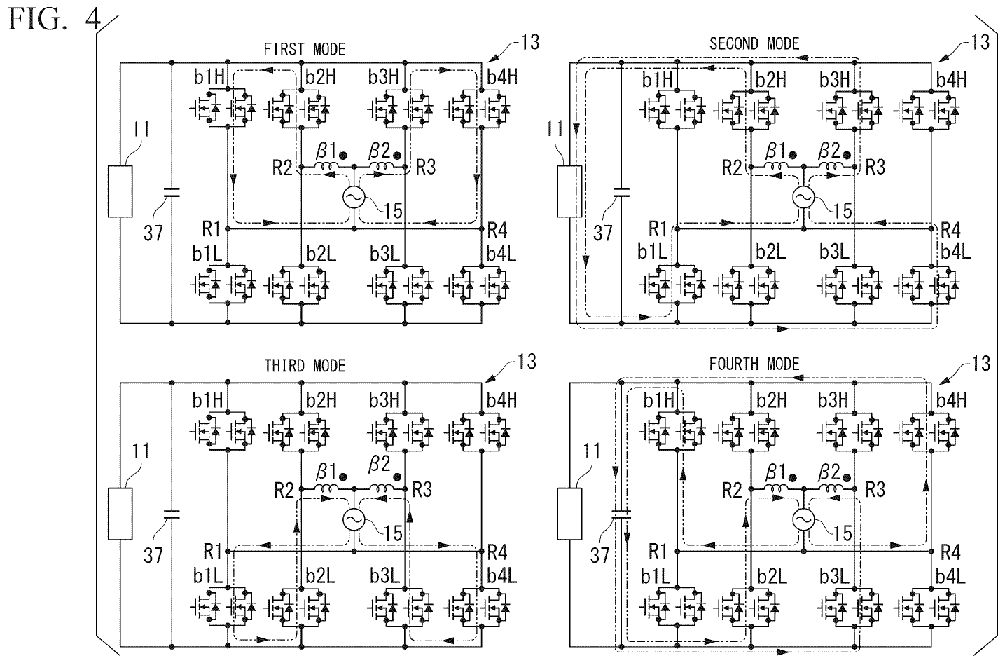

FIG. 4 is a circuit diagram showing the flow of a current in each state of a first mode, a second mode, a third mode, and a fourth mode in the state of a mirror drive at the time of AC charging in the electric apparatus 10 of the embodiment.

As shown in FIG. 4, in the state of the mirror drive at the time of AC charging, currents in an opposite direction to each other flow from the AC electric power source connection portion 15 to the β-phase first coil 33 (β1) and the β-phase second coil 34 (β2), respectively. The currents that flow through the β-phase first coil 33 (β1) and the β-phase second coil 34 (β2) are currents of reverse phases in which magnetic fluxes cancel each other out. The magnetic fluxes of the β-phase coils 33 (β1), 34 (β2) cancel each other out, and thereby, a voltage increase operation is performed by a leakage inductance due to the leakage magnetic flux of the β-phase coils 33 (β1), 34 (β2).

For example, as shown in Table 1 described below, the ON (conduction) and the OFF (cutoff) of each of a first element portion E1, a second element portion E2, a third element portion E3, and a fourth device portion E4 is switched in accordance with each state of the first mode, the second mode, the third mode, and the fourth mode. The first element portion E1 is a combination of the low-side arm element portion 31b (b1L) in the first phase of the third full-bridge circuit 13a and the low-side arm element portion 31b (b4L) in the second phase of the fourth full-bridge circuit 13b. The second element portion E2 is a combination of the high-side arm element portion 31a (b1H) in the first phase of the third full-bridge circuit 13a and the high-side arm element portion 31a (b4H) in the second phase of the fourth full-bridge circuit 13b. The third element portion E3 is a combination of the low-side arm element portion 31b (b2L) in the second phase of the third full-bridge circuit 13a and the low-side arm element portion 31b (b3L) in the first phase of the fourth full-bridge circuit 13b. The fourth element portion E4 is a combination of the high-side arm element portion 31a (b2H) in the second phase of the third full-bridge circuit 13a and the high-side arm element portion 31a (b3H) in the first phase of the fourth full-bridge circuit 13b.

TABLE 1

| | ELEMENT PORTION | | | |
|---|---|---|---|---|
| | E1 | E2 | E3 | E4 |
| MODE | (b1L, b4L) | (b1H, b4H) | (b2L, b3L) | (b2H, b3H) |
| FIRST MODE | OFF | ON | OFF | ON |
| SECOND MODE | ON | OFF | OFF | ON |
| THIRD MODE | ON | OFF | ON | OFF |
| FOURTH MODE | OFF | ON | ON | OFF |

The first mode is a state in which an upper-side half wave of an input voltage Vac of the external AC electric power source is applied, and the β-phase coils 33 (β1), 34 (β2) are charged.

The second mode is a state in which the upper-side half wave of the input voltage Vac of the external AC electric power source is applied, and the β-phase coils 33 (β1), 34 (β2) are discharged.

The third mode is a state in which a lower-side half wave of the input voltage Vac of the external AC electric power source is applied, and the β-phase coils 33 (β1), 34 (β2) are charged.

The fourth mode is a state in which the lower-side half wave of the input voltage Vac of the external AC electric power source is applied, and the β-phase coils 33 (β1), 34 (β2) are discharged.

For example, the electronic control unit 18 sets a condition for prohibiting a reverse flow from the capacitor 37 with respect to each state the second mode and the fourth mode shown in Table 1 described above.

For example, the electronic control unit 18 switches the state of each element portion 31a (b1H), 31b (b1L), 31a (b2H), 31b (b2L) in the first phase and the second phase of the third full-bridge circuit 13a to the state of the first mode when the input voltage Vac is positive (>0), and the current of the β-phase first coil 33 (β1) is negative (<0) in the state of the second mode. Further, the state is switched to the state of the third mode when the input voltage Vac is negative (<0), and the current of the β-phase first coil 33 (β1) is positive (>0) in the state of the fourth mode.

For example, the electronic control unit 18 switches the state of each element portion 31a (b3H), 31b (b3L), 31a (b4H), 31b (b4L) in the first phase and the second phase of the fourth full-bridge circuit 13b to the state of the first mode when the input voltage Vac is positive (>0), and the current of the β-phase second coil 34 (β2) is positive (>0) in the state of the second mode. Further, the state is switched to the state of the third mode when the input voltage Vac is negative (<0), and the current of the β-phase second coil 34 (β2) is negative (<0) in the state of the fourth mode.

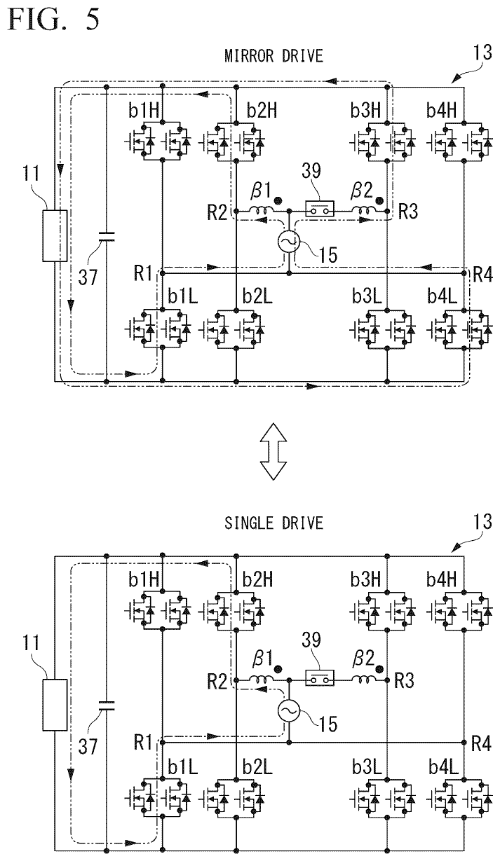

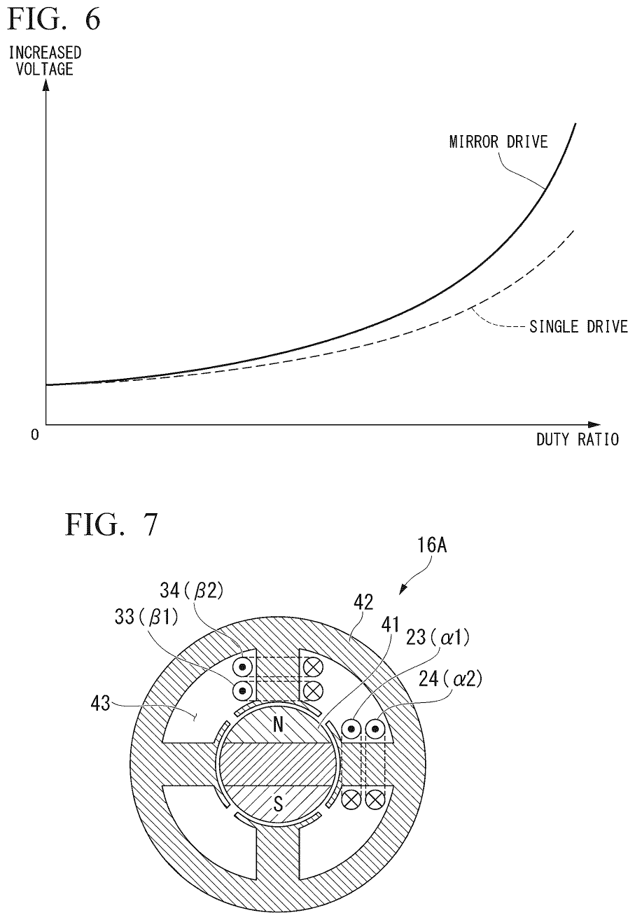

FIG. 5 is a circuit diagram showing an example of the flow of a current in each state of the mirror drive and a single drive at the time of AC charging in the electric apparatus 10 of the embodiment. FIG. 6 is a view showing an example of a correspondence relationship between an increased voltage and a duty of switching in each state of the mirror drive and the single drive at the time of AC charging in the electric apparatus 10 of the embodiment.

Each example shown in FIG. 5 is the second mode, and in the case of the single drive, electric power supply from the external AC electric power source to the β-phase second coil 34 (β2) is cut off by the OFF (cutoff) state of the fifth connection-disconnection device 39. In the case of the single drive, the voltage increase operation is performed by the inductance of the β-phase first coil 33 (β1) to which electric power is supplied from the external AC electric power source.

As shown in FIG. 6, as compared with the single drive in which the voltage increase operation is performed by the inductance of the β-phase first coil 33 (β1), in the mirror drive in which the voltage increase operation is performed by a smaller leakage inductance, for example, even when the input voltage Vac is small, it is possible to increase the voltage increase ratio.

As described above, according to the electric apparatus 10 of the embodiment, by supplying electric power to the β-phase coils 33 (β1), 34 (β2) that are arranged in the same slot 43 such that the magnetic fluxes cancel each other out, it is possible to prevent the rotary electric machine 16 (M) from generating torque, and it is possible to increase the voltage increase ratio by a relatively small leakage inductance.

The β-phase coils 33 (β1), 34 (β2) are, for example, an open-end winding that is connected to each full-bridge circuit 13a, 13b, and thereby, for example, as compared with a three-phase coil or the like, it is possible to increase the voltage applied to each β-phase coil 33 (β1), 34 (β2) with respect to a charging voltage and increase the charging speed.

The combination of the α-phase coils 23 (α1), 24 (α2) of the rotary electric machine 16 (M), the first full-bridge circuit 12a, and the second full-bridge circuit 12b can function as an insulation-type bidirectional DC-DC converter. For example, in the case of the voltage increase operation, it is possible to perform rapid charging with respect to the voltage of the electricity storage device 11 that is larger than the charging voltage by the external AC electric power source.

By the switching operation of the first full-bridge circuit 12a and the second full-bridge circuit 12b, it is possible to prevent the rotary electric machine 16 (M) from generating torque, and it is possible to increase the voltage increase ratio by a relatively small leakage inductance.

When the voltage of the external AC electric power source is less than the predetermined voltage, by supplying electric power such that the magnetic fluxes of the β-phase coils 33 (β1), 34 (β2) cancel each other out, it is possible to increase the voltage increase ratio by a relatively small leakage inductance. When the voltage of the external AC electric power source is equal to or more than the predetermined voltage, it is possible to improve the charging efficiency while reducing distortion of a current or the like by a relatively large inductance using the single drive.

### Modification Example

Hereinafter, modification examples of the embodiment will be described. The same parts as those of the above-described embodiment are denoted by the same reference numerals, and descriptions thereof are omitted or simplified.

The above embodiment is described using an example in which each of the α-phase first coil 23 (α1), the α-phase second coil 24 (α2), the β-phase first coil 33 (β1), and the β-phase second coil 34 (β2) is wound around the different teeth of the stator core 42; however, the embodiment is not limited thereto.

FIG. 7 is a configuration view of a rotary electric machine 16A of the electric apparatus 10 in a modification example of the embodiment.

As shown in FIG. 7, the α-phase first coil 23 (α1) and the α-phase second coil 24 (α2) may be wound around the same teeth of the stator core 42, and the β-phase first coil 33 (β1) and the β-phase second coil 34 (β2) may be wound around the same teeth of the stator core 42.

The above embodiment is described using an example in which the second electric power conversion portion 13 includes the fifth connection-disconnection device 39, and in the case of the single drive, electric power supply from the external AC electric power source to the β-phase second coil 34 (β2) is cut off by the OFF (cutoff) state of the fifth connection-disconnection device 39; however, the embodiment is not limited thereto.

For example, the second electric power conversion portion 13 may include a sixth connection-disconnection device that switches between ON (conduction) and OFF (cutoff) of the connection between the AC electric power source connection portion 15 and the β-phase first coil 33 (β1), and in the case of the single drive, electric power supply from the external AC electric power source to the β-phase first coil 33 (β1) may be cut off by the OFF (cutoff) state of the sixth connection-disconnection device. In this case, electric power is supplied from the external AC electric power source to the β-phase second coil 34 (β2) by the ON (conduction) of the fifth connection-disconnection device 39.

Further, for example, instead of the single drive, currents in the same direction as each other, that is, in-phase currents in which the magnetic fluxes are not canceled each other may flow through the β-phase first coil 33 (β1) and the β-phase second coil 34 (β2).

Further, for example, the switching operation of the third full-bridge circuit 13a or the fourth full-bridge circuit 13b is stopped by the OFF (cutoff) of each switching element in the third full-bridge circuit 13a or the fourth full-bridge circuit 13b, and thereby, the single drive may be performed.

The above embodiment is described using an example in which the β-phase first coil 33 (β1) and the β-phase second coil 34 (β2) are magnetically coupled to each other in the same polarity; however, the embodiment is not limited thereto. The β-phase first coil 33 (β1) and the β-phase second coil 34 (β2) may be magnetically coupled to each other in an opposite polarity. In this case, for example, a connection-disconnection device connected between one end of the β-phase first coil 33 (β1) and the neutral point R2 of the second phase of the third full-bridge circuit 13a or a connection-disconnection device connected between one end of the β-phase second coil 34 (β2) and the neutral point R3 of the first phase of the fourth full-bridge circuit 13b may be provided. That is, in the state of the mirror drive at the time of AC charging, a current in a flow direction such that the magnetic fluxes are cancelled each other may flow in accordance with the polarity of the magnetic coupling of the β-phase first coil 33 (β1) and the β-phase second coil 34 (β2).

The above embodiment is described using an example in which, in the functional configuration of the electronic control unit 18 at the time of AC charging in the electric apparatus 10, it is not necessary to acquire the phase of the input voltage Vac of the external AC electric power source; however, the embodiment is not limited thereto. For example, a phase acquisition portion that acquires the phase of the input voltage Vac of the external AC electric power source may be provided. In this case, for example, a target current synchronized with the input voltage Vac of the external AC electric power source may be acquired based on the phase of the input voltage Vac that is output from the phase acquisition portion and a current amplitude target value of the input current Iac.

The above embodiment is described using an example in which, as a parallel pattern, the DC electric power source connection portion 14 is connected to the negative electrode of the second electric power conversion portion 13 and to the neutral point (that is, a point between the two transistors connected reversely in series) of each of the first switch 22 and the second switch 32; however, the embodiment is not limited thereto. For example, as a serial pattern, the DC electric power source connection portion 14 may be connected to the negative electrode of the second electric power conversion portion 13 and to the neutral point Q4 of the first electric power conversion portion 12 and the neutral point R4 of the second electric power conversion portion 13. For example, as another parallel pattern, the DC electric power source connection portion 14 may be connected to the negative electrode of the second electric power conversion portion 13 and to the neutral points Q2, Q4 of the first electric power conversion portion 12 and the neutral points R2, R4 of the second electric power conversion portion 13.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electricity storage device and a rotary electric machine;
an electric power control unit that is connected to the electricity storage device and the rotary electric machine and controls electric power transfer of each of the electricity storage device and the rotary electric machine; and
an electric power source connection member that connects the electric power control unit to an external electric power source, wherein
the rotary electric machine comprises:
a first coil;
a second coil; and
a stator core on which a slot shared by the first coil and the second coil is formed,
the electric power control unit comprises:
a first full-bridge circuit that is connected to both ends of the first coil;
a second full-bridge circuit that is connected to both ends of the second coil;
a first connection-disconnection device that is connected between one end of the first coil and the first full-bridge circuit; and
a second connection-disconnection device that is connected between one end of the second coil and the second full-bridge circuit, and
the electric power source connection member is connected to both ends of each of the first connection-disconnection device and the second connection-disconnection device such that magnetic fluxes are cancelled each other when a current supplied from the external electric power source to the first coil and the second coil that are magnetically coupled flows.

2. The electric apparatus according to claim 1,
wherein the rotary electric machine comprises a third coil and a fourth coil that share the slot of the stator core, and
the electric power control unit comprises:
a third full-bridge circuit that is connected to both ends of the third coil;
a fourth full-bridge circuit that is connected to both ends of the fourth coil;
a third connection-disconnection device that is connected between positive electrodes of the third full-bridge circuit and the fourth full-bridge circuit; and
a fourth connection-disconnection device that is connected between negative electrodes of the third full-bridge circuit and the fourth full-bridge circuit.

3. The electric apparatus according to claim 1,
wherein when the electricity storage device is charged by the external electric power source,
each of the first connection-disconnection device and the second connection-disconnection device is set to be in a disconnection state, and
the first full-bridge circuit and the second full-bridge circuit set a flow direction in the first coil and the second coil of the current supplied from the external electric power source such that the magnetic fluxes of the first coil and the second coil that are magnetically coupled cancel each other out.

4. The electric apparatus according to claim 1,
wherein the electric power control unit stops a switching operation of the first full-bridge circuit or the second full-bridge circuit when a voltage of the external electric power source is equal to or more than a predetermined voltage.

5. The electric apparatus according to claim 1, comprising:
an electric power source connection-disconnection device that is connected between the electric power source connection member and the first connection-disconnection device or the second connection-disconnection device,
wherein the electric power source connection-disconnection device is set to be in a connection state when a voltage of the external electric power source is less than a predetermined voltage, and
the electric power source connection-disconnection device is set to be in a disconnection state when the voltage of the external electric power source is equal to or more than the predetermined voltage.
